(19) United States
(12) Patent Application Publication
(10) Pub. No.: US 2024/0364543 A1
(43) Pub. Date: Oct. 31, 2024

(54) SECURE TRANSMISSION OF CONTENT UPDATES VIA QKD NETWORKS

(71) Applicant: Red Hat, Inc., Raleigh, NC (US)

(72) Inventors: Leigh Griffin, Waterford (IE); Stephen Coady, Dublin (IE)

(21) Appl. No.: 18/307,324

(22) Filed: Apr. 26, 2023

(51) Int. Cl. H04L 9/36

(52) U.S. Cl. CPC H04L 9/36; G06N 10/70

(57) ABSTRACT

A quantum computing device determines that an error occurred during a transmission of an update for content from a server computing device to a client computing device over a quantum communication channel (QCC) that is using a quantum key distribution (QKD) protocol and a key generated by the QKD protocol. The quantum computing device determines a risk of discovery of a vulnerability in the update for the content based on a severity level of the vulnerability in the update for the content transmitted from the server computing device to the client computing device over the QCC, an amount of the key discovered, and an amount of the update for the content transmitted from the server computing device to the client computing device over the QCC discovered. The quantum computing device performs an action based on the risk of discovery of the vulnerability in the update for the content.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices. As quantum computing continues to increase in popularity and become more commonplace, an ability to efficiently and accurately allocate qubits in real time will be desirable.

### SUMMARY

The examples disclosed herein implement a quantum key distribution (QKD) error monitor that performs secure transmission of content updates via QKD networks. In particular, the QKD error monitor can be a component of a content delivery network (CDN) where an update to content, such as a software patch, is being transmitted between a server computing device and a client computing device that are connected via a quantum communication channel that is using a QKD protocol. The QKD error monitor can determine that an error occurred during the transmission of the update and perform an action based on the risk of discovery of a vulnerability, such as a Common Vulnerability and Exposure, in the update due to the error in order to prevent disclosure of the vulnerability.

In one example, a method for secure transmission of content updates via QKD networks is disclosed. The method includes determining, by a quantum computing device, that a first error occurred during a transmission of an update for content from a server computing device to a client computing device over a quantum communication channel that is using a quantum key distribution (QKD) protocol and a first key generated by the QKD protocol. The method further includes determining, by the quantum computing device, a risk of discovery of a vulnerability in the update for the content based on a severity level of the vulnerability in the update for the content transmitted from the server computing device to the client computing device over the quantum communication channel, an amount of the first key discovered, and an amount of the update for the content transmitted from the server computing device to the client computing device over the quantum communication channel discovered. The method further includes performing, by the quantum computing device, a first action based on the risk of discovery of the vulnerability in the update for the content.

In another example, a quantum computing device for secure transmission of content updates via QKD networks is disclosed. The quantum computing device comprises a system memory, and a processor device communicatively coupled to the system memory. The processor device is to determine that a first error occurred during a transmission of an update for content from a server computing device to a client computing device over a quantum communication channel that is using a quantum key distribution (QKD) protocol and a first key generated by the QKD protocol. The processor device is further to determine a risk of discovery of a vulnerability in the update for the content based on a severity level of the vulnerability in the update for the content transmitted from the server computing device to the client computing device over the quantum communication channel, an amount of the first key discovered, and an amount of the update for the content transmitted from the server computing device to the client computing device over the quantum communication channel discovered. The processor device is further to perform a first action based on the risk of discovery of the vulnerability in the update for the content.

In another example, a non-transitory computer-readable storage medium is disclosed. The non-transitory computer-readable storage medium stores thereon computer-executable instructions that, when executed, cause one or more processor devices to determine that a first error occurred during a transmission of an update for content from a server computing device to a client computing device over a quantum communication channel that is using a quantum key distribution (QKD) protocol and a first key generated by the QKD protocol. The instructions further cause the processor device to determine a risk of discovery of a vulnerability in the update for the content based on a severity level of the vulnerability in the update for the content transmitted from the server computing device to the client computing device over the quantum communication channel, an amount of the first key discovered, and an amount of the update for the content transmitted from the server computing device to the client computing device over the quantum communication channel discovered. The instructions further cause the processor device to perform a first action based on the risk of discovery of the vulnerability in the update for the content.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum computing system in which examples of secure transmission of content updates via QKD networks may be practiced;

FIG. 2 is a flowchart illustrating operations performed by the quantum computing system of FIG. 1 for secure transmission of content updates via QKD networks, according to one example;

FIG. 3 is a block diagram of the quantum computing system of FIG. 1 for secure transmission of content updates via QKD networks, according to one example;

FIG. 4 is a block diagram of the quantum computing system of FIG. 1 for secure transmission of content updates via QKD networks, according to one example;

FIG. 5 is a block diagram of the quantum computing system of FIG. 1 for secure transmission of content updates via QKD networks, according to one example;

FIG. 6 is a block diagram of the quantum computing system of FIG. 1 for secure transmission of content updates via QKD networks, according to one example;

FIG. 7 is a block diagram of the quantum computing system of FIG. 1 for secure transmission of content updates via QKD networks, according to one example; and

FIG. 8 is a block diagram of a quantum computing system suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first executing quantum service” and “second executing quantum service,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the elements unless otherwise explicitly specified. The word “or” as used herein and in the claims is inclusive unless contextually impossible. As an example, the recitation of A or B means A, or B, or both A and B.

Quantum computing involves the use of quantum bits, referred to herein as “qubits,” which have characteristics that differ from those of classical (i.e., non-quantum) bits used in classical computing. Qubits may be employed by quantum services that are executed by quantum computing devices in a quantum computing system.

In a quantum computing system, quantum services, quantum computing devices, and other components of the quantum computing system may need to be updated, such as by a patch for the quantum service, quantum computing device, or other component. The patch may address a vulnerability or security flaw of the quantum service, quantum computing device, or other component, and the vulnerability or security flaw may be identified in the patch by a Common Vulnerabilities and Exposures (CVE) identifier. The CVE identifier may have been assigned to the security flaw before the security flaw has been publicly disclosed and thus must be kept secret for an amount of time. As a result, the patch must be securely transmitted so that the patch can be delivered (e.g., from a vendor to a customer) and applied to the quantum service, quantum computing device, or other component without being discovered, as a discovery of the vulnerability or CVE identifier by a third party can result in public disclosure of the vulnerability or CVE identifier prior to the expiration of the amount of time that the vulnerability or CVE identifier is required to be kept secret.

The examples disclosed herein implement a quantum key distribution (QKD) error monitor that performs secure transmission of content updates via QKD networks. The QKD error monitor can be a component of a content delivery network (CDN) where an update to content, such as a patch, is being transmitted between a server computing device and a client computing device that are connected via a quantum communication channel that is using a QKD protocol and a key generated by the QKD protocol to protect the quantum communication channel. QKD is a secure communication method that enables parties to generate a key that is known only to the parties and allows for the parties to detect the presence of an intruder trying to ascertain the key by detecting errors introduced into the key. The QKD error monitor can determine that an error occurred during the transmission of the update (e.g., the patch) and perform an action based on the risk of discovery of a vulnerability, such as the discovery of an undisclosed CVE identifier, in the update due to the error in order to prevent public disclosure of the vulnerability that is required to be kept secret.

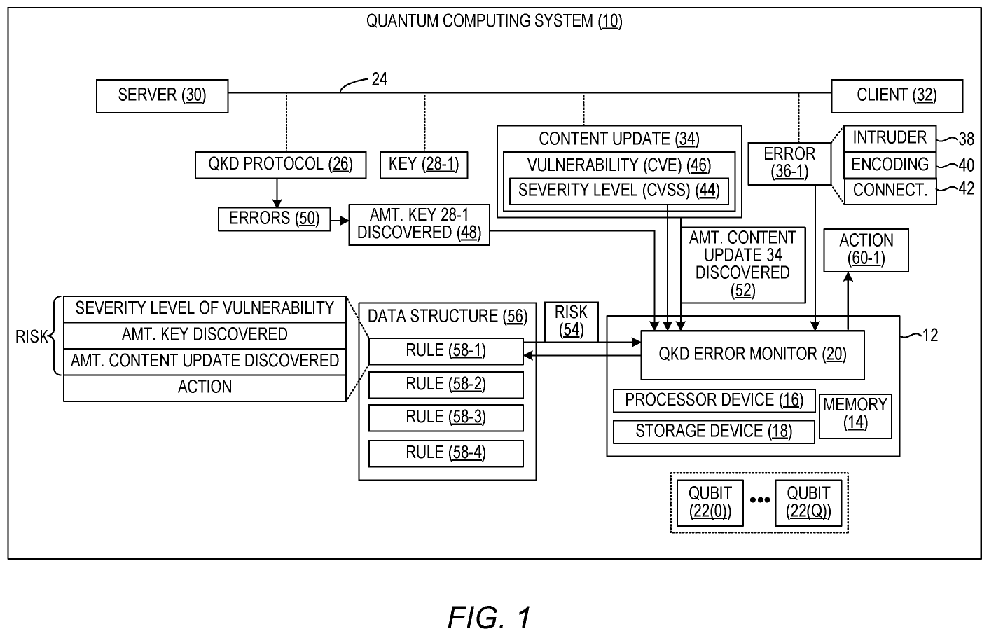

FIG. 1 is a block diagram of a quantum computing system in which examples of secure transmission of content updates via QKD networks may be practiced. In the example of FIG. 1, a quantum computing system 10 includes a quantum computing device 12 that comprises a system memory 14, a processor device 16, and a storage device 18. It is to be understood that the quantum computing system 10 in some examples may include constituent elements in addition to those illustrated in FIG. 1. In the example of FIG. 1, the quantum computing device 12 implements a QKD error monitor 20 that performs secure transmission of content updates via QKD networks.

The quantum computing system 10 implements a set of one or more qubits 22(0)-22(Q) and a quantum communication channel 24. The set of one or more qubits 22(0)-22(Q) may be utilized by quantum services executed in the quantum computing system 10, such as the QKD error monitor 20. Quantum services, such as the QKD error monitor 20, are processes that employ qubits, such as the set of one or more qubits 22(0)-22(Q), to provide desired functionality. The quantum communication channel 24 may utilize a QKD protocol 26, such as, by way of non-limiting example, a BB84 QKD protocol. The QKD protocol 26 may be used in conjunction with the qubits 22(0)-22(Q) and the quantum communication channel 24 to generate a first key 28-1. The first key 28-1 may be used to protect the quantum communication channel 24 and the transmissions of content, such as files and media, over the quantum communication channel 24.

The quantum computing system 10 includes a server computing device 30 and a client computing device 32 that can transmit a content update 34 from the server computing device 30 to the client computing device 32 over the quantum communication channel 24. The server computing device 30 may be a quantum computing device or a classical computing device, and the client computing device 32 may be a quantum computing device or a classical computing device. The content update 34 may be, by way of non-limiting example, a file or other media, such as a security patch or software patch for a quantum service or other component of the quantum computing system 10. The first key 28-1 may be transmitted over the quantum communication channel 24 that is using the QKD protocol 26 and transmitting the content update 34 from the server computing device 30 to the client computing device 32. The first key 28-1 can be used to encrypt or decrypt the content update 34 that is being transmitted over the quantum communication channel 24 from the server computing device 30 to the client computing device 32.

The QKD error monitor 20 can determine that a first error 36-1 occurred during the transmission of the content update 34 from the server computing device 30 to the client computing device 32 over the quantum communication channel 24. The first error 36-1 may be an error introduced by an intruder 38 or third party attempting to discover the first key 28-1, an error in an encoding 40 of the content update 34, or a defective connection 42 of the quantum communication channel 24, as non-limiting examples.

The QKD error monitor 20 can determine a severity level 44 of a vulnerability 46 in the content update 34 that is being transmitted from the server computing device 30 to the client computing device 32 over the quantum communication channel 24. For example, the QKD error monitor 20 may obtain the severity level 44 of the vulnerability 46 from the content update 34, such as by reading the content update 34 when the content update 34 is a file and identifying the vulnerability 46 and the severity level 44 of the vulnerability in the text or code of the content update 34. In some examples, the vulnerability 46 in the content update 34 may be referred to by a Common Vulnerabilities and Exposures (CVE) identifier and the severity level 44 of the vulnerability 46 in the content update 34 may be a Common Vulnerability Scoring System (CVSS) score. A CVE identifier can identify a security flaw that the content update 34 is addressing, such as when the content update 34 is a security patch to a quantum service in the quantum computing system 10 and the patch names the CVE identifier that the patch is addressing in the quantum service, as one non-limiting example. CVE identifiers allow users to recognize vulnerabilities, however, CVE identifiers are often assigned to a security flaw before the security flaw is publicly disclosed and are kept secret until a fix for the security flaw has been developed. Therefore, when the vulnerability 46 in the content update 34 includes a fix for a security flaw that is identified by a CVE identifier that is not publicly disclosed, the content update 34 must be securely transmitted over the quantum communication channel 24 from the server computing device 30 where the content update 34 is stored to the client computing device 32 that implements the fix in the content update 34. CVE identifiers can further include a CVSS score that evaluates the severity and impact of the vulnerability that the CVE identifier corresponds to, which can be a numerical value with higher numbers indicating higher degrees of severity and impact of the vulnerability. A high CVSS score may indicate that any potential risk of discovery of a CVE identifier should result in shutting down a system, while a lower CVSS score may indicate that some risk of discovery of a CVE identifier is tolerable. For example, the QKD error monitor 20 can determine that the first error 36-1 occurred during the transmission of the content update 34 from the server computing device 30 to the client computing device 32 over the quantum communication channel 24 where the content update 34 includes the vulnerability 46 identified by a CVE identifier that is not publicly disclosed. The QKD error monitor 20 can then determine the severity level 44 of the vulnerability 46 identified by the secret CVE identifier by reading the content update 34 and discovering the CVE identifier and CVSS score. The QKD error monitor 20 can also determine an amount 48 of the first

key 28-1 discovered due to the first error 36-1. For example, the QKD error monitor 20 may obtain an amount of errors 50 that were introduced into the first key 28-1 as a result of the first error 36-1. The amount of errors 50 can be obtained from the QKD protocol 26, such as via an application programming interface (API) that corresponds to the QKD protocol 26 where the QKD error monitor 20 can send a request to the API for an amount of errors introduced into the first key 28-1 and the QKD error monitor 20 can receive a response from the API that identifies the amount of errors 50 that were introduced into the first key 28-1, as a non-limiting example. In another example, in order to determine the amount 48 of the first key 28-1 discovered due to the first error 36-1, the QKD error monitor 20 may obtain the amount 48 of the first key 28-1 discovered from the QKD protocol 26, such as by sending a request to the API that corresponds to the QKD protocol 26 for an amount of the first key 28-1 discovered and receiving a response from the API that identifies a percentage of the first key 28-1 that was discovered due to the first error 36-1.

The QKD error monitor 20 can also determine an amount 52 of the content update 34 discovered due to the first error 36-1. For instance, a quantity of the content update 34 that has been transmitted from the server computing device 30 to the client computing device 32 over the quantum communication channel 24 when the first error 36-1 occurred can be determined by the QKD error monitor 20 in order to determine the amount 52 of the content update 34 discovered due to the first error 36-1. For example, 30% of the content update 34 may have been transmitted from the server computing device 30 to the client computing device 32 over the quantum communication channel 24 when the first error 36-1 occurred. The QKD error monitor 20 can detect that 30% of the content update 34 has been transmitted already and that 70% of the content update 34 is still to be transmitted from the server computing device 30 to the client computing device 32, and use these metrics to determine that the amount 52 of the content update 34 discovered was 30% of the content update 34 or an amount less than 30%. In some implementations, the content update 34 can be separated into segments and each segment can be transmitted separately from the server computing device 30 to the client computing device 32 over the quantum communication channel 24. In such an implementation, the QKD error monitor 20 can determine the amount 52 of the content update 34 discovered due to the first error 36-1 by determining that three out of ten segments of the segmented content update 34 have been transmitted from the server computing device 30 to the client computing device 32 over the quantum communication channel 24 when the first error 36-1 occurred. The QKD error monitor 20 can use such information to determine that 30% of the content update 34 has been transmitted already and that 70% of the content update 34 is still to be transmitted, and use these metrics to determine that the amount 52 of the content update 34 discovered was 30% of the content update 34 or an amount less than 30%.

The QKD error monitor 20 can determine a risk 54 of discovery of the vulnerability 46 in the content update 34 based on the severity level 44 of the vulnerability 46 in the content update 34 that is being transmitted from the server computing device 30 to the client computing device 32 over the quantum communication channel 24, the amount 48 of the first key 28-1 discovered due to the first error 36-1, and the amount 52 of the content update 34 transmitted from the server computing device 30 to the client computing device 32 over the quantum communication channel 24 and discovered due to the first error 36-1. In some implementations, the QKD error monitor 20 can determine the risk 54 of discovery of the vulnerability 46 in the content update 34 by accessing a data structure 56 that includes rules that identify an action to take based on a severity level of a vulnerability in a content update, an amount of a key of the quantum communication channel discovered, and an amount of the content update discovered. The data structure 56 may be a table, as a non-limiting example, and can be stored in a storage device of the quantum computing system 10, such as, by way of non-limiting example, a database. For instance, when the data structure 56 is a table, each rule may be a row in the table that is indexed by the severity level (e.g., CVSS score) of a vulnerability (e.g., CVE identifier) in a content update with columns that identify an amount of a key discovered, an amount of the content update discovered, and an action to take. The action identified in the rule can correspond to a risk of discovery of the vulnerability in the content update, as the risk (e.g., the risk 54) can be based on the severity level of the vulnerability in the content update that is being transmitted from the server computing device to the client computing device over the quantum communication channel, the amount of the key discovered due to the error, and the amount of the content update transmitted from the server computing device to the client computing device over the quantum communication channel and discovered due to the error. The action in the rule can correspond to the risk of discovery of the vulnerability in the content update in order to prevent discovery of the vulnerability that has not been publicly disclosed, thus more drastic actions may be taken when there is a higher risk of discovery of the vulnerability. For instance, the action in the rule may be more drastic when the risk of discovery of the vulnerability in the content update is high or the action in the rule may be minor when the risk of discovery of the vulnerability in the content update is low. The risk of discovery of the vulnerability in the content update may be higher when the vulnerability in the update has a high severity level, the amount of the key discovered is high, and/or a large amount of the content update was discovered, and lower when the update has a low severity level, a small amount of the key was discovered, and/or a small amount of the content update was discovered.

The QKD error monitor 20 can obtain a rule 58-1 from among a plurality of rules 58-1-58-4 in the data structure 56. The rule 58-1 obtained from the data structure 56 can be obtained based on the severity level 44 of the vulnerability 46 in the content update 34 that is being transmitted from the server computing device 30 to the client computing device 32 over the quantum communication channel 24, the amount 48 of the first key 28-1 discovered due to the first error 36-1, and the amount 52 of the content update 34 transmitted from the server computing device 30 to the client computing device 32 over the quantum communication channel 24 and discovered due to the first error 36-1.

For example, the QKD error monitor 20 can determine that the first error 36-1 occurred during the transmission of the content update 34 from the server computing device 30 to the client computing device 32 over the quantum communication channel 24, determine the severity level 44 of the vulnerability 46 in the content update 34, such as by reading the content update 34 for a CVE identifier and CVSS score, determine the amount 48 of the first key 28-1 discovered due to the first error 36-1, such as by obtaining the amount of errors 50 introduced into the first key 28-1 from the QKD protocol 26, and determine the amount 52 of the content update 34 discovered due to the first error 36-1, such as by identifying the quantity of the content update 34 that had been transmitted when the first error 36-1 occurred. Collectively, the severity level 44 of the vulnerability 46 in the content update 34, the amount 48 of the first key 28-1 discovered, and the amount 52 of the content update 34 discovered can be associated with the risk 54 of discovery of the vulnerability 46 in the content update 34. The QKD error monitor 20 can use the risk 54 of discovery of the vulnerability 46 in the content update 34 (i.e., the severity level 44 of the vulnerability 46 in the content update 34, the amount 48 of the first key 28-1 discovered, and the amount 52 of the content update 34 discovered to access the data structure 56) to obtain the rule 58-1 that contains a corresponding risk or severity level of the vulnerability in the content update, amount of the key discovered, and amount of the content update discovered. The rule 58-1 obtained by the QKD error monitor 20 can identify the action for the QKD error monitor 20 to take in order to prevent discovery of the vulnerability in the content update that has not been publicly disclosed.

The QKD error monitor 20 can perform a first action 60-1 based on the risk 54 of discovery of the vulnerability 46 in the content update 34. The rule 58-1 obtained from the data structure 56 can identify an action to take in the implementation where the QKD error monitor 20 can determine the risk 54 of discovery of the vulnerability 46 in the content update 34 by accessing a data structure 56 that includes rules that identify an action to take based on a severity level of a vulnerability in a content update, an amount of a key of the quantum communication channel discovered, and an amount of the content update discovered. The QKD error monitor 20 can obtain the rule 58-1 based on the severity level 44 of the vulnerability 46 in the content update 34 that is being transmitted from the server computing device 30 to the client computing device 32 over the quantum communication channel 24, the amount 48 of the first key 28-1 discovered due to the first error 36-1, and the amount 52 of the content update 34 transmitted from the server computing device 30 to the client computing device 32 over the quantum communication channel 24 and discovered due to the first error 36-1, then identify the first action 60-1 in the rule 58-1 and perform the first action 60-1. For example, the QKD error monitor 20 can determine that the severity level 44 of the vulnerability 46 in the content update 34 is high, such as by identifying a high CVSS score in the content update 34, the amount 48 of the first key 28-1 discovered is 50%, and the amount 52 of the content update 34 discovered is 40%. The QKD error monitor 20 can use such information to obtain the rule 58-1 that contains the corresponding high CVSS score, 50% amount of a key discovered, and 40% of a content update discovered. The rule 58-1 may indicate that the action for the QKD error monitor 20 to take in order to prevent discovery of the vulnerability 46 in the content update 34 is the first action 60-1. The QKD error monitor 20 can then perform the first action 60-1, such as stopping the transmission of the content update 34 from the server computing device 30 to the client computing device 32, as one non-limiting example.

In some examples, after obtaining the rule 58-1 from the data structure 56, the rule 58-1 can be updated based on the amount 48 of the first key 28-1 and the amount 52 of the content update 34 discovered due to the first error 36-1. For example, a rule in the data structure 56 may indicate that the action to take when 20% of the key is discovered and 10% of the content update is discovered is to continue transmitting the content update from the server computing device 30 to the client computing device 32 over the quantum communication channel 24. The QKD error monitor 20 may access this rule more than one time (e.g., due to errors occurring more than one time) and update the rule to indicate that the action should be taken instead when 10% of the key is discovered due to the history of errors in the transmission.

It is to be understood that, because the QKD error monitor 20 is a component of the quantum computing device 12, functionality implemented by the QKD error monitor 20 may be attributed to the quantum computing device 12 generally. Moreover, in examples where the QKD error monitor 20 comprises software instructions that program the processor device 16 to carry out functionality discussed herein, functionality implemented by the QKD error monitor 20 may be attributed herein to the processor device 16. It is to be further understood that while, for purposes of illustration only, the QKD error monitor 20 is depicted as a single component, the functionality implemented by the QKD error monitor 20 may be implemented in any number of components, and the examples discussed herein are not limited to any particular number of components.

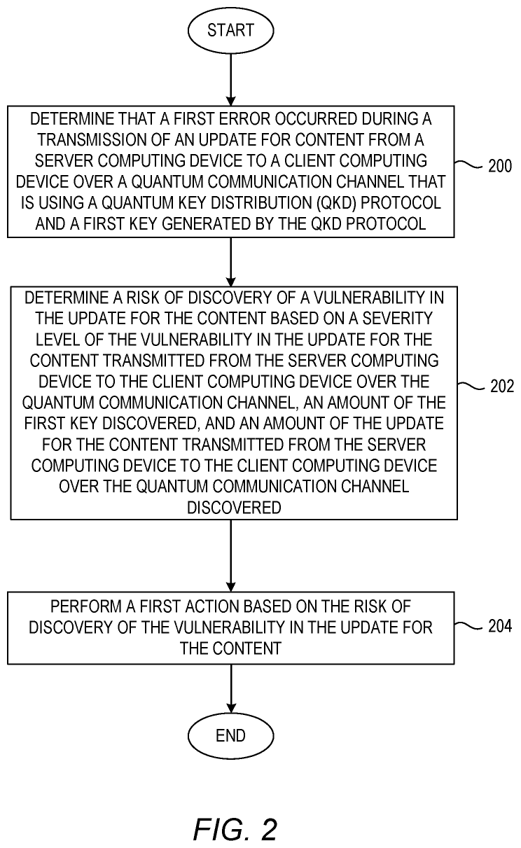

FIG. 2 is a flowchart illustrating operations performed by the quantum computing system 10 of FIG. 1 for secure transmission of content updates via QKD networks, according to one example. Elements of FIG. 1 are referenced in describing FIG. 2 for the sake of clarity. In the example of FIG. 2, operations begin with a processor device of a quantum computing device, such as the processor device 16 of the quantum computing device 12 of FIG. 1, to determine that a first error occurred during a transmission of an update for content from a server computing device to a client computing device over a quantum communication channel that is using a quantum key distribution (QKD) protocol and a first key generated by the QKD protocol (block 200). The processor device 16 is then to determine a risk of discovery of a vulnerability in the update for the content based on a severity level of the vulnerability in the update for the content transmitted from the server computing device to the client computing device over the quantum communication channel, an amount of the first key discovered, and an amount of the update for the content transmitted from the server computing device to the client computing device over the quantum communication channel discovered (block 202). The processor device 16 is then to perform a first action based on the risk of discovery of the vulnerability in the update for the content (block 204).

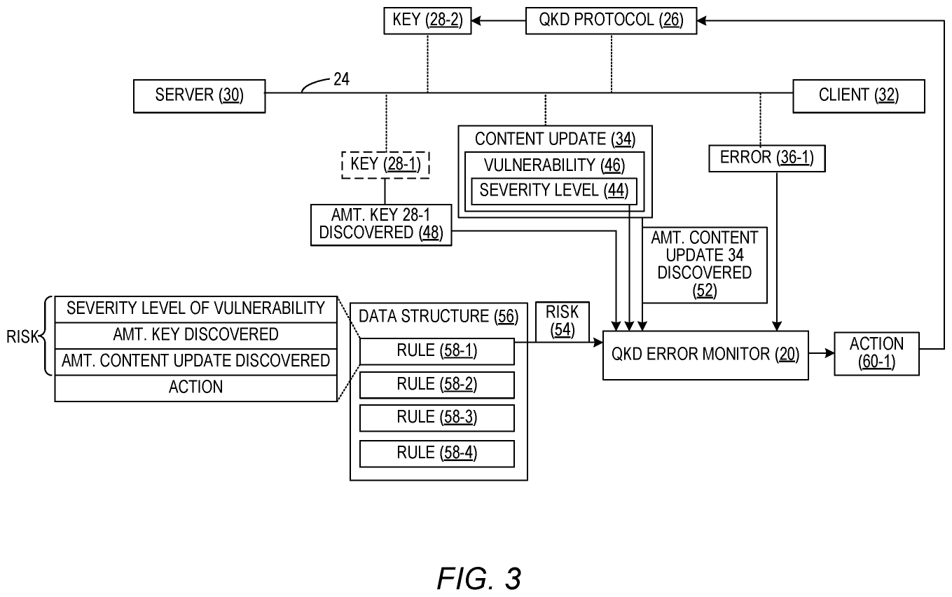

FIG. 3 is a block diagram of the quantum computing system 10 of FIG. 1 for secure transmission of content updates via QKD networks, according to one example. Elements of FIG. 1 are referenced in describing FIG. 3 for the sake of clarity. In the example of FIG. 3, the first action 60-1 performed by the QKD error monitor 20 based on the risk 54 of discovery of the vulnerability 46 in the content update 34 may be to generate a second key 28-2 for the quantum communication channel 24 to utilize in the transmission of the content update 34 from the server computing device 30 to the client computing device 32. The QKD error monitor 20 can transition the quantum communication channel 24 from using the first key 28-1 to using the second key 28-2. The QKD protocol 26 may be used in conjunction with the qubits 22(0)-22(Q) and the quantum communication channel 24 to generate the second key 28-2. The second key 28-2 may be used to protect the quantum communication channel 24 and the transmissions of content over the quantum communication channel 24 once the QKD error monitor 20 transitions the quantum communication channel 24 from using the first key 28-1 to using the second key 28-2. The second key 28-2 may also be transmitted over the quantum communication channel 24 that is using the QKD protocol 26 and transmitting the content update 34 from the server computing device 30 to the client computing device 32. The second key 28-2 can be used to encrypt or decrypt the content update 34 that is being transmitted over the quantum communication channel 24 from the server computing device 30 to the client computing device 32 instead of using the first key 28-1 to encrypt or decrypt the content update 34. Transitioning the quantum communication channel 24 from using the first key 28-1 to using the second key 28-2 can include instructing the server computing device 30 and the client computing device 32 to use the second key 28-2 instead of the first key 28-1, such as by sending a message and the second key 28-2 to the server computing device 30 and the client computing device 32, as one non-limiting example.

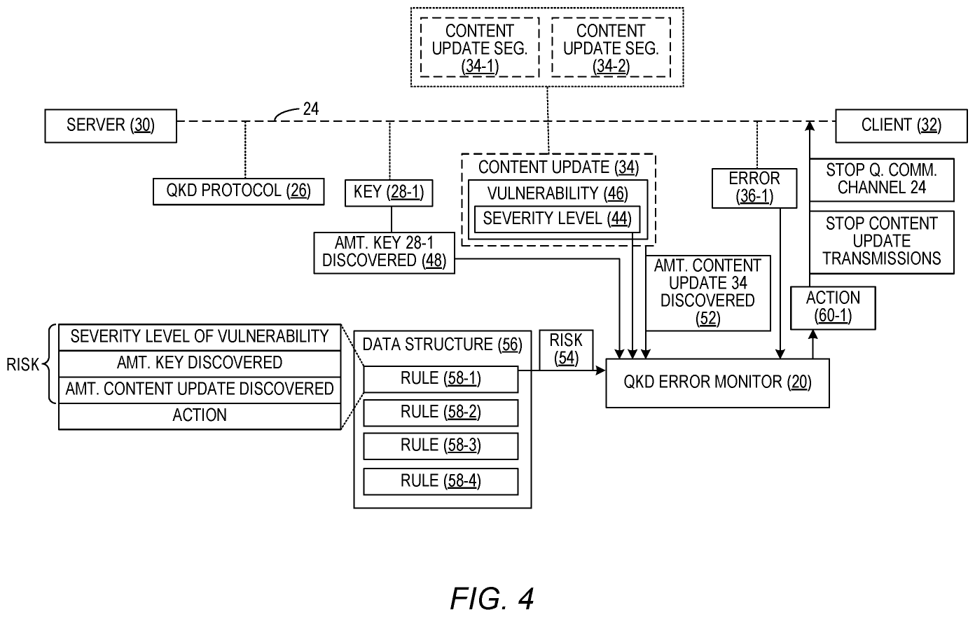

FIG. 4 is a block diagram of the quantum computing system 10 of FIG. 1 for secure transmission of content updates via QKD networks, according to one example. Elements of FIG. 1 are referenced in describing FIG. 4 for the sake of clarity. In the example of FIG. 4, the first action 60-1 performed by the QKD error monitor 20 based on the risk 54 of discovery of the vulnerability 46 in the content update 34 may be to stop the transmission of the content update 34 from the server computing device 30 to the client computing device 32 over the quantum communication channel 24. In some implementations, the first action 60-1 may include both stopping the transmission of the content update 34 from the server computing device 30 to the client computing device 32 over the quantum communication channel 24 and stopping the transmission of all content, such as files and other media, from the server computing device 30 to the client computing device 32 over the quantum communication channel 24. The QKD error monitor 20 may then stop the quantum communication channel 24 in order for no further content to be able to be transmitted over the quantum communication channel 24.

In some examples, the content update 34 can be separated into multiple parts and the transmission of the content update 34 from the server computing device 30 to the client computing device 32 over the quantum communication channel 24 can include transmitting each segment of the content update 34 from the server computing device 30 to the client computing device 32 over the quantum communication channel 24. Each segment of the content update 34 can be transmitted over the quantum communication channel 24 sequentially. After sending a segment of the content update 34 from the server computing device 30 to the client computing device 32 over the quantum communication channel 24, the QKD error monitor 20 can wait for an acknowledgment from the client computing device 32 that the segment was received and then send the next segment of the content update 34 from the server computing device 30 to the client computing device 32 over the quantum communication channel 24. In this example, stopping the transmission of the content update 34 from the server computing device 30 to the client computing device 32 over the quantum communication channel 24 can include stopping the transmission of a segment of the content update 34 from the server computing device 30 to the client computing device 32 over the quantum communication channel 24. Then, the QKD error monitor 20 can stop the quantum communication channel 24 from being able to send the remaining segments of the content update 34, or pause the sending of the segments of the content update 34 and resume sending the segments of the content update 34 after a predetermined period of time or event occurs.

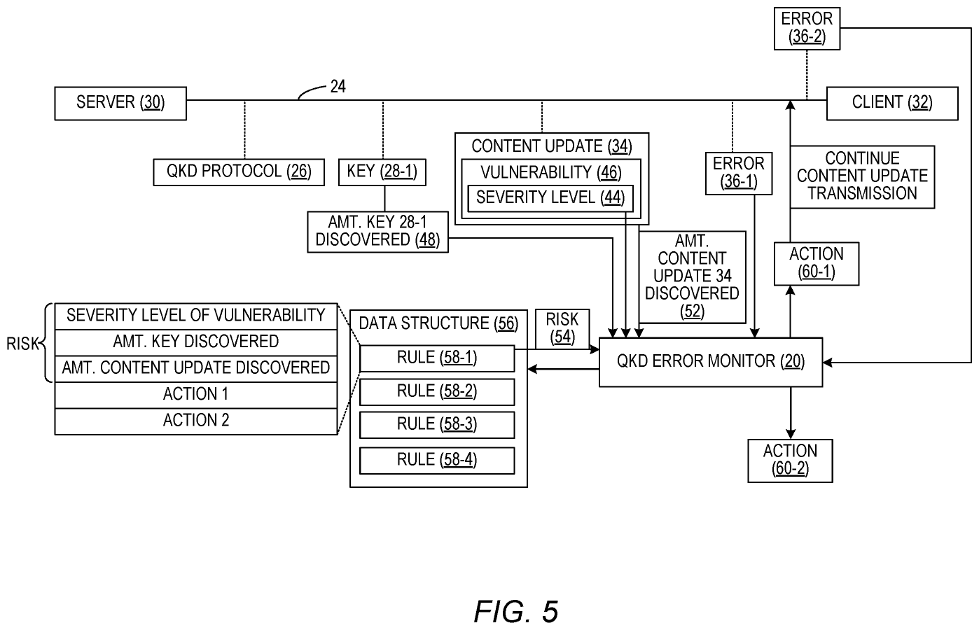

FIG. 5 is a block diagram of the quantum computing system 10 of FIG. 1 for secure transmission of content updates via QKD networks, according to one example. Elements of FIG. 1 are referenced in describing FIG. 5 for the sake of clarity. In the example of FIG. 5, the first action 60-1 performed by the QKD error monitor 20 based on the risk 54 of discovery of the vulnerability 46 in the content update 34 may be to continue the transmission of the content update 34 from the server computing device 30 to the client computing device 32 over the quantum communication channel 24. The QKD error monitor 20 may then determine that a second error 36-2 occurred during the continued transmission of the content update 34 from the server computing device 30 to the client computing device 32 over the quantum communication channel 24.

In some implementations, the rules in the data structure 56 can identify more than one action to take based on a severity level of a vulnerability in a content update that is being transmitted from the server computing device to the client computing device over the quantum communication channel, an amount of a key of the quantum communication channel discovered, and an amount of the content update discovered. The actions identified in the rule can correspond to the risk of discovery of the vulnerability in the content update, as the risk (e.g., the risk 54) can be based on the severity level of the vulnerability in the content update, the amount of the key discovered, and the amount of the content update discovered. The rules in the data structure 56 that identify more than one action to take can order the actions in order of priority, where the first action can be performed when a first error occurs and the subsequent actions can be performed when subsequent errors occur. For instance, a rule in the data structure 56 may indicate that the first action to take when a first error occurs and the severity level of the vulnerability is low, 10% of the key is discovered, and 20% of the content update is discovered, is to continue transmitting the content update from the server computing device to the client computing device over the quantum communication channel 24, the second action to take (e.g., when a second error occurs) is to generate a new key for the quantum communication channel to use, and the third action to take (e.g., when a third error occurs) is to stop the transmission of the content update from the server computing device to the client computing device over the quantum communication channel. As a result of the hierarchy of actions in a rule, more aggressive actions can be taken in order to reduce the risk of discovery of the vulnerability in a content update when errors occur.

The QKD error monitor 20 can access the data structure 56 and obtain the rule 58-1 from the data structure 56 in response to the second error 36-2. The rule 58-1 obtained by the QKD error monitor 20 may be the same rule that was obtained by the QKD error monitor 20 when the first error 36-1 occurred and the QKD error monitor 20 determined the risk 54 of discovery of the vulnerability 46 in the content update 34 based on the severity level 44 of the vulnerability 46 in the content update 34 being transmitted from the server computing device 30 to the client computing device 32 over the quantum communication channel 24, the amount 48 of the first key 28-1 discovered due to the first error 36-1, and the amount 52 of the content update 34 transmitted from the server computing device 30 to the client computing device 32 over the quantum communication channel 24 and discovered due to the first error 36-1. The rule 58-1 may identify a second action 60-2 to take based on the severity level 44 of the vulnerability 46 in the content update 34 that is being transmitted from the server computing device 30 to the client computing device 32 over the quantum communication channel 24, the amount 48 of the first key 28-1 discovered due to the second error 36-2, and the amount 52 of the content update 34 transmitted from the server computing device 30 to the client computing device 32 over the quantum communication channel 24 and discovered due to the second error 36-2. The QKD error monitor 20 can perform the second action 60-2 based on the rule 58-1. The second action 60-2 may be to generate a second key for use by the quantum communication channel 24 and transitioning the quantum communication channel 24 to use the second key, stopping the transmission of a segment of the content update 34 from the server computing device 30 to the client computing device 32, stopping the transmission of the content update 34 from the server computing device 30 to the client computing device 32, stopping the transmission of all content from the server computing device 30 to the client computing device 32, stopping the quantum communication channel 24, or continuing the transmission of the content update 34 from the server computing device 30 to the client computing device 32, as non-limiting examples.

In some implementations, in response to determining that the second error 36-2 occurred during the continued transmission of the content update 34 from the server computing device 30 to the client computing device 32 over the quantum communication channel 24, the QKD error monitor 20 may obtain a second rule 58-2 from the data structure 56. For example, the QKD error monitor 20 may determine that the severity level 44 of the vulnerability 46 in the content update 34 is medium, the amount 48 of the first key 28-1 discovered due to the first error 36-1 was 20%, and the amount 52 of the content update 34 discovered due to the first error 36-1 was 30%, obtain the rule 58-1 from the data structure 56 that corresponds to this information, and perform the first action 60-1 identified in the rule 58-1, where the first action 60-1 is to continue the transmission of the content update 34 from the server computing device 30 to the client computing device 32 over the quantum communication channel 24. Then, the QKD error monitor 20 may determine that the second error 36-2 occurred during the continued transmission of the content update 34 from the server computing device 30 to the client computing device 32 over the quantum communication channel 24 and that the amount 48 of the first key 28-1 discovered due to the second error 36-2 is 50% and the amount 52 of the content update 34 discovered due to the second error 36-2 was 60%. The QKD error monitor 20 may then access the data structure 56 and obtain the second rule 58-2, which corresponds to a medium severity level of the vulnerability in the content update, 50% of the key discovered, and 60% of the content update discovered, and identifies an action to take. The QKD error monitor 20 may then perform the action identified in the second rule 58-2, which may be more a more aggressive action due to an increase in the amount of the first key 28-1 discovered and the amount of the content update 34 discovered due to the second error 36-2, such as stopping the transmission of the content update 34 from the server computing device 30 to the client computing device 32 over the quantum communication channel 24, as one non-limiting example.

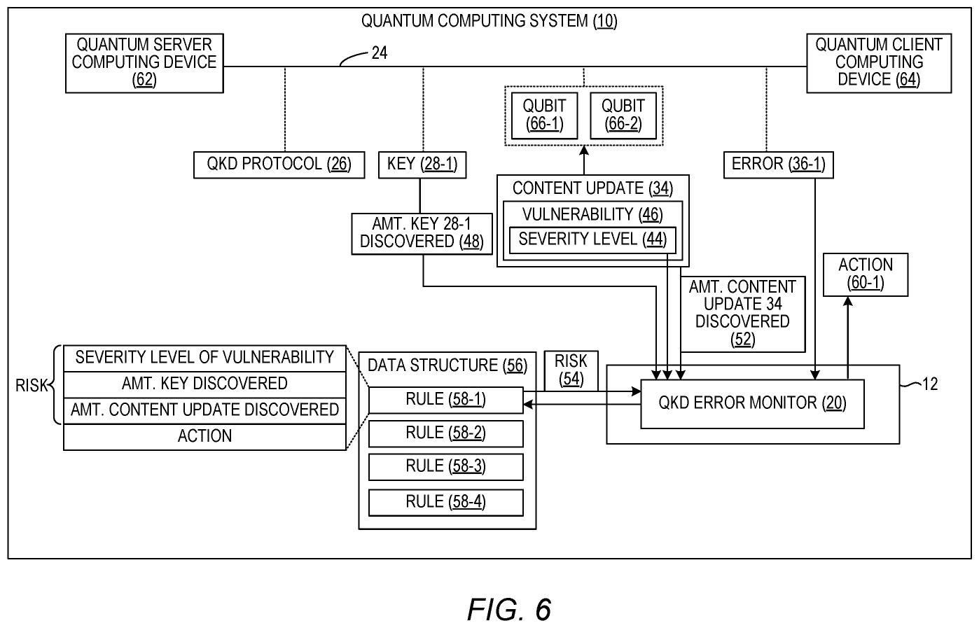

FIG. 6 is a block diagram of the quantum computing system 10 of FIG. 1 for secure transmission of content updates via QKD networks, according to one example. Elements of FIG. 1 are referenced in describing FIG. 6 for the sake of clarity. In the example of FIG. 6, the server computing device 30 may be a quantum server computing device 62 of the quantum computing system 10 and the client computing device 32 may be a quantum client computing device 64 of the quantum computing system 10. In the example where the server computing device 30 and the client computing device 32 are quantum computing devices of the quantum computing system 10, the transmission of the content update 34 from the server computing device 30 to the client computing device 32 over the quantum communication channel 24 can include the transmission of a plurality of qubits 66-1, 66-2 from the quantum server computing device 62 to the quantum client computing device 64. The plurality of qubits 66-1, 66-2 can be transmitted from the quantum server computing device 62 to the quantum client computing device 64 as a result of first encoding the content update 34 into the plurality of qubits 66-1, 66-2 and then transmitting the plurality of qubits 66-1, 66-2 over the quantum communication channel 24. The QKD error monitor 20 may determine that the first error 36-1 occurred during the transmission of the plurality of qubits 66-1, 66-2 from the quantum server computing device 62 to the quantum client computing device 64 over the quantum communication channel 24. For example, the QKD error monitor 20 may determine that an intruder 38 or third party manipulated or read one or more of the plurality of qubits 66-1, 66-2 in order for the QKD error monitor 20 to determine that the first error 36-1 occurred during transmission of the plurality of qubits 66-1, 66-2 from the quantum server computing device 62 to the quantum client computing device 64 over the quantum communication channel 24.

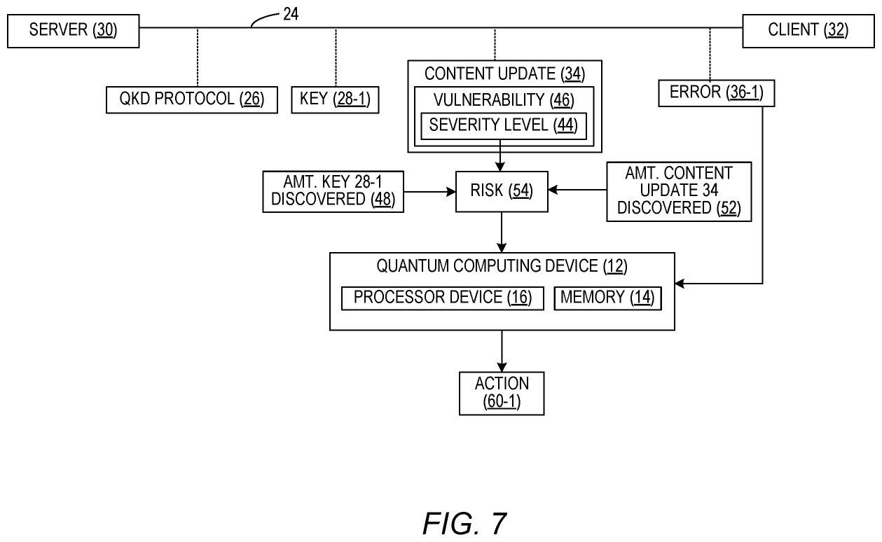

FIG. 7 is a block diagram of the quantum computing system 10 of FIG. 1 for secure transmission of content updates via QKD networks, according to one example. Elements of FIG. 1 are referenced in describing FIG. 7 for the sake of clarity. In the example of FIG. 7, a quantum computing device 12 comprises the system memory 14 and the processor device 16 coupled to the system memory 14. The processor device 16 is to determine that a first error 36-1 occurred during a transmission of an update for content 34 from a server computing device 30 to a client computing device 32 over a quantum communication channel 24 that is using a quantum key distribution (QKD) protocol 26 and a first key 28-1 generated by the QKD protocol 26. The processor device 16 is further to determine a risk 54 of discovery of a vulnerability 46 in the update for the content 34 based on a severity level 44 of the vulnerability 46 in the update for the content 34 transmitted from the server computing device 30 to the client computing device 32 over the quantum communication channel 24, an amount 48 of the first key 28-1 discovered, and an amount 52 of the update for the content 34 transmitted from the server computing device 30 to the client computing device 32 over the quantum communication channel 24 discovered. The processor device 16 is further to perform a first action 60-1 based on the risk 54 of discovery of the vulnerability 46 in the update for the content 34.

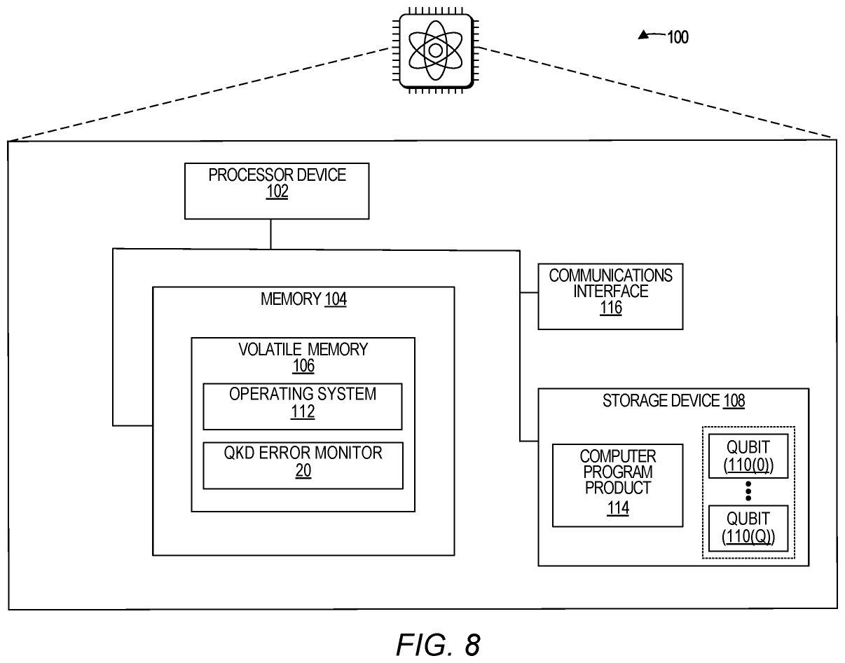

FIG. 8 is a block diagram of a quantum computing device 100, such as the quantum computing device 12 of FIG. 1, suitable for implementing examples according to one example. The quantum computing device 100 may comprise any suitable quantum computing device or devices. The quantum computing device 100 can operate using classical computing principles or quantum computing principles. Thus, in some implementations, portions of the quantum computing device 100 (e.g., the QKD error monitor 20) may be executed using classical computing components and/or algorithms. When using quantum computing principles, the quantum computing device 100 performs computations that utilize quantum-mechanical phenomena, such as superposition and entanglement. The quantum computing device 100 may operate under certain environmental conditions, such as at or near zero degrees (0°) Kelvin. When using classical computing principles, the quantum computing device 100 utilizes binary digits that have a value of either zero (0) or one (1).

The quantum computing device 100 includes a processor device 102, such as the processor device 16 of FIG. 1, and a system memory 104, such as the system memory 14 of FIG. 1. The processor device 102 can be any commercially available or proprietary processor suitable for operating in a quantum environment. The system memory 104 may include volatile memory 106 (e.g., random-access memory (RAM)).

The quantum computing device 100 may further include or be coupled to a non-transitory computer-readable medium such as a storage device 108, such as the storage device 18 of FIG. 1. The storage device 108 may comprise, for example, an internal or external hard disk drive (HDD) (e.g., enhanced integrated drive electronics (EIDE) or serial advanced technology attachment (SATA)) for storage, memory, or the like. The storage device 108 and other drives associated with computer-readable media and computer-usable media may provide non-volatile storage of data, data structures, computer-executable instructions, and the like. The storage device may also provide functionality for storing one or more qubits 110(0)-110(Q).

A number of modules can be stored in the storage device 108 and in the volatile memory 106, including an operating system 112 and one or more modules, such as the QKD error monitor 20. All or a portion of the examples may be implemented as a computer program product 114 stored on a transitory or non-transitory computer-usable or computer-readable medium, such as the storage device 108, which includes complex programming instructions, such as complex computer-readable program code, to cause the processor device 102 to carry out the steps described herein. Thus, the computer-readable program code can comprise computer-executable instructions for implementing the functionality of the examples described herein when executed on the processor device 102.

An operator may also be able to enter one or more configuration commands through a keyboard (not illustrated), a pointing device such as a mouse (not illustrated), or a touch-sensitive surface such as a display device (not illustrated). The quantum computing device 100 may also include a communications interface 116 suitable for communicating with other quantum computing systems, including, in some implementations, classical computing devices.

Individuals will recognize improvements and modifications to the preferred examples of the disclosure. All such improvements and modifications are considered within the scope of the concepts disclosed herein and the claims that follow.

What is claimed is:

1. A method, comprising:
determining, by a quantum computing device, that a first error occurred during a transmission of an update for content from a server computing device to a client computing device over a quantum communication channel that is using a quantum key distribution (QKD) protocol and a first key generated by the QKD protocol;
determining, by the quantum computing device, a risk of discovery of a vulnerability in the update for the content based on a severity level of the vulnerability in the update for the content transmitted from the server computing device to the client computing device over the quantum communication channel, an amount of the first key discovered, and an amount of the update for the content transmitted from the server computing device to the client computing device over the quantum communication channel discovered; and
performing, by the quantum computing device, a first action based on the risk of discovery of the vulnerability in the update for the content.

2. The method of claim 1, further comprising:
determining the severity level of the vulnerability in the update for the content;
determining the amount of the first key discovered; and
determining the amount of the update for the content discovered.

3. The method of claim 2, wherein determining the severity level of the vulnerability in the update for the content comprises obtaining, from the update for the content, the severity level of the vulnerability.

4. The method of claim 2, wherein determining the amount of the first key discovered comprises obtaining, from the QKD protocol, an amount of errors introduced into the first key.

5. The method of claim 2, wherein the amount of the update for the content comprises a quantity of the update for the content transmitted from the server computing device to the client computing device over the quantum communication channel when the first error occurred.

6. The method of claim 1, wherein determining the risk of discovery of the vulnerability in the update for the content based on the severity level of the vulnerability in the update for the content, the amount of the first key discovered, and the amount of the update for the content discovered comprises:
accessing a data structure comprising a plurality of rules, each rule identifying an action to take based on a severity level of a vulnerability in an update for content, an amount of a key discovered, and an amount of an update for content discovered; and
obtaining a rule from among the plurality of rules in the data structure based on the severity level of the vulnerability in the update for the content transmitted from the server computing device to the client computing device over the quantum communication channel, the amount of the first key discovered, and the amount of the update for the content transmitted from the server computing device to the client computing device over the quantum communication channel discovered;
wherein the action in the rule corresponds to the risk of discovery of the vulnerability in the update for the content.

7. The method of claim 6, further comprising:
subsequent to obtaining the rule from among the plurality of rules in the data structure, updating the rule based on the amount of the first key discovered and the amount of the update for the content transmitted from the server computing device to the client computing device over the quantum communication channel discovered.

8. The method of claim 6, further comprising:
identifying, in the rule, an action to take; and
wherein performing the first action based on the risk of discovery of the vulnerability in the update for the content comprises performing the action identified in the rule.

9. The method of claim 1, wherein performing the first action based on the risk of discovery of the vulnerability in the update for the content comprises:
generating, by the QKD protocol, a second key for use by the quantum communication channel; and
transitioning the quantum communication channel to use the second key.

10. The method of claim 1, wherein performing the first action based on the risk of discovery of the vulnerability in the update for the content comprises:
stopping the transmission of the update for the content from the server computing device to the client computing device over the quantum communication channel; and
stopping the quantum communication channel.

11. The method of claim 10, wherein stopping the transmission of the update for the content from the server computing device to the client computing device over the quantum communication channel comprises:
stopping the transmission of a segment of the update for the content from the server computing device to the client computing device over the quantum communication channel, wherein the update for the content is separated into a plurality of segments and the transmission of the update for the content from the server computing device to the client computing device over the quantum communication channel comprises a transmission of each segment of the plurality of segments from the server computing device to the client computing device over the quantum communication channel.

12. The method of claim 1, wherein performing the first action based on the risk of discovery of the vulnerability in the update for the content comprises continuing the transmission of the update for the content from the server computing device to the client computing device over the quantum communication channel.

13. The method of claim 12, further comprising:
determining that a second error occurred during the transmission of the update for the content from the server computing device to the client computing device over the quantum communication channel;
stopping the transmission of the update for the content from the server computing device to the client computing device over the quantum communication channel;
accessing a data structure comprising a plurality of rules, each rule identifying actions to take based on a severity level of a vulnerability in an update for content, an amount of a key discovered, and an amount of an update for content discovered; and
obtaining a rule from among the plurality of rules in the data structure, wherein the rule identifies a second action to take based on the severity level of the vulnerability in the update for the content transmitted from the server computing device to the client computing device over the quantum communication channel, the amount of the first key discovered, and the amount of the update for the content transmitted from the server computing device to the client computing device over the quantum communication channel discovered.

14. The method of claim 13, further comprising:
identifying, in the rule, the second action to take; and
performing, based on the rule, the second action.

15. The method of claim 1, wherein the server computing device is a quantum computing device and the client computing device is a quantum computing device.

16. The method of claim 15, further comprising:
encoding the update for the content into a plurality of qubits, wherein the transmission of the update for the content from the server computing device to the client computing device over the quantum communication channel comprises a transmission of the plurality of qubits from the server computing device to the client computing device over the quantum communication channel.

17. The method of claim 1, wherein the vulnerability in the update for the content is referred to by a Common Vulnerabilities and Exposures (CVE) identifier and the severity level of the vulnerability in the update for the content is a Common Vulnerability Scoring System (CVSS) score.

18. The method of claim 1, wherein the first error comprises one or more of an error introduced by an intruder attempting to discover the first key, an error in an encoding of the update for the content, or a defective connection of the quantum communication channel.

19. A quantum computing device, comprising:
a memory; and
a processor device coupled to the memory, the processor device to:
determine that a first error occurred during a transmission of an update for content from a server computing device to a client computing device over a quantum communication channel that is using a quantum key distribution (QKD) protocol and a first key generated by the QKD protocol;
determine a risk of discovery of a vulnerability in the update for the content based on a severity level of the vulnerability in the update for the content transmitted from the server computing device to the client computing device over the quantum communication channel, an amount of the first key discovered, and an amount of the update for the content transmitted from the server computing device to the client computing device over the quantum communication channel discovered; and
perform a first action based on the risk of discovery of the vulnerability in the update for the content.

20. A non-transitory computer-readable storage medium that includes computer-executable instructions that, when executed, cause one or more processor devices to:
determine that a first error occurred during a transmission of an update for content from a server computing device to a client computing device over a quantum communication channel that is using a quantum key distribution (QKD) protocol and a first key generated by the QKD protocol;
determine a risk of discovery of a vulnerability in the update for the content based on a severity level of the vulnerability in the update for the content transmitted from the server computing device to the client computing device over the quantum communication channel, an amount of the first key discovered, and an amount of the update for the content transmitted from the server computing device to the client computing device over the quantum communication channel discovered; and
perform a first action based on the risk of discovery of the vulnerability in the update for the content.
